(19) United States
(12) Patent Application Publication
(10) Pub. No.: US 2024/0347862 A1
(43) Pub. Date: Oct. 17, 2024

(54) BATTERY CELL, BATTERY, AND ELECTRICAL DEVICE

(71) Applicant: Dongguan Amperex Technology Limited, Dongguan City (CN)

(72) Inventors: Yingyang Wu, Dongguan City (CN); Dongou Zhan, Dongguan City (CN); Xin Jin, Dongguan City (CN)

(73) Assignee: Dongguan Amperex Technology Limited, Dongguan City (CN)

(21) Appl. No.: 18/757,822

(22) Filed: Jun. 28, 2024

Related U.S. Application Data
(63) Continuation of application No. PCT/CN2021/143820, filed on Dec. 31, 2021.

(51) Int. Cl. H01M 50/46; H01M 50/105; H01M 50/533; H01M 50/536

(52) U.S. Cl. CPC H01M 50/461; H01M 50/105; H01M 50/533; H01M 50/536

(57) ABSTRACT

A battery cell includes an electrode assembly and a first tab. The electrode assembly includes a separator. An outer surface of the electrode assembly includes a first lateral face and a second lateral face disposed opposite to each other along a first direction, and a first end face and a second end face disposed opposite to each other along a second direction. One end of the first tab is electrically connected to the first electrode plate, and another end of the first tab extends out from the first end face. The first tab includes a first surface and a second surface. The first surface is oriented toward the first lateral face, and the second surface is oriented away from the first lateral face. The first end face includes a first region. The first region is located between the first surface and the first lateral face.

### CROSS-REFERENCE TO RELATED APPLICATION

This application is a continuation of International Patent Application No. PCT/CN2021/143820, filed on Dec. 31, 2021, the disclosure of which is hereby incorporated by reference in its entirety.

### TECHNICAL FIELD

This application relates to the technical field of batteries, and in particular, to a battery cell, a battery, and an electrical device.

### BACKGROUND

When a battery in actual use is impacted in a case of dropping, the separator of a battery cell in the battery is prone to shrink inward as impacted by an electrolyte solution, resulting in a short circuit, heat generation, and other phenomena of the battery cell, and reducing the safety of the battery cell.

### SUMMARY

In view of the foregoing situation, it is necessary to provide a battery cell to improve safety of the battery cell.

An embodiment of this application provides a battery cell. The battery cell includes an electrode assembly and a first tab. The electrode assembly includes a first electrode plate, a second electrode plate, and a separator disposed between the first electrode plate and the second electrode plate. An outer surface of the electrode assembly includes a first lateral face and a second lateral face disposed opposite to each other along a first direction, and a first end face and a second end face disposed opposite to each other along a second direction. One end of the first tab is electrically connected to the first electrode plate, and another end of the first tab extends out from the first end face. The first tab includes a first surface and a second surface. The first surface is oriented toward the first lateral face, and the second surface is oriented away from the first lateral face. The first end face includes a first region. The first region is located between the first surface and the first lateral face. The battery cell further includes a first adhesive layer and a second adhesive layer. The first adhesive layer is affixed to the first region and extends from the first region to the first lateral face. A part of the first adhesive layer is bonded to the separator located at the first region. The second adhesive layer is bonded to at least a part of the second surface and extends from the second surface to the second lateral face. A part of the second adhesive layer is bonded to the separator located at the first end face.

The first adhesive layer makes the separator at the first region and the first lateral face form a whole, and the second adhesive layer makes a part of the separator at the first end face and the second lateral face form a whole, so as to reduce the risk of a short circuit of the battery cell caused by inward shrinkage of the separator at the first end face when the battery cell is dropping, and improve the safety of the battery cell.

In some embodiments of this application, a third direction is perpendicular to the first direction and the second direction. Along the third direction, a ratio of a width of the first adhesive layer to a width of the electrode assembly ranges from 3/4 to 6/5; and/or a ratio of a width of the second adhesive layer to a width of the electrode assembly ranges from 3/4 to 6/5. When the ratio of the width of the first adhesive layer to the width of the electrode assembly is 3/4 to 1, the width of the first adhesive layer falls within the width range of the electrode assembly to facilitate reduction of the amount of the first adhesive layer consumed. When the ratio of the width of the first adhesive layer to the width of the electrode assembly is 1 to 6/5, along the third direction, a part of the first adhesive layer, which extends beyond the electrode assembly, may be connected to the two sides of the electrode assembly along the third direction to increase the bonding area of the first adhesive layer, and in turn, improve the bonding stability of the first adhesive layer.

In some embodiments of this application, the first adhesive layer includes a first part and a second part connected to the first part. The first part is bonded to the first lateral face and the first region separately. Along the first direction, the second part is partially bonded to the first surface. The first part is configured to be bonded to the separator located at the first region, and make the separator at the first region combine with the first lateral face to form a whole. The second part is partially bonded to the first surface, and further makes the first tab, the separator at the first region, and the first lateral face form a whole, so as to reduce the risk of a short circuit of the battery cell caused by inward shrinkage of the separator at the first end face when the battery cell is dropping, and improve the safety of the battery cell.

In some embodiments of this application, the electrode assembly further includes a third lateral face and a fourth lateral face disposed opposite to each other along a third direction. In the third direction, two corresponding ends of the first adhesive layer extend to be flush with the third lateral face and the fourth lateral face, respectively. In this way, when subjected to a pulling force of the first adhesive layer, the first lateral face can distribute the pulling force uniformly, thereby reducing the risk of tearing the first lateral face due to nonuniform force distribution.

In some embodiments of this application, the first adhesive layer further includes a third part and a fourth part. The third part is bonded to the third lateral face. The fourth part is bonded to the fourth lateral face. In this way, the first lateral face, the separator at the first region, the third lateral face, and the fourth lateral face form a whole, so as to further reduce the risk of a short circuit of the battery cell caused by inward shrinkage of the separator at the first end face when the battery cell is dropping.

In some embodiments of this application, a part, extending out of the first end face, of the first tab is bent from the second lateral face toward the first lateral face, so as to reduce the packaging space occupied by the first tab in the second direction and increase the energy density of the battery.

In some embodiments of this application, the battery cell further includes a packaging bag in which the electrode assembly is accommodated and a first tab lead. One end of the first tab lead is disposed on the first surface or the second surface, and another end of the first tab lead extends out of the packaging bag. The second part is partially bonded to a surface of the first tab lead, or the second adhesive layer is partially bonded to a surface of the first tab lead, so as to reduce the risk of a short circuit caused by the contact between the first tab lead and the electrode assembly.

In some embodiments of this application, the battery cell further includes a second tab. One end of the second tab is electrically connected to the electrode assembly, and another end of the second tab extends out from the first end face. The second tab includes a third surface and a fourth surface. The third surface is oriented toward the first lateral face, and the fourth surface is oriented away from the first lateral face. The first end face includes a second region. The second region is located between the third surface and the first lateral face. The first adhesive layer further extends from the first region to the second region. A part of the first adhesive layer is bonded to the separator located at the second region, and the second adhesive layer is further bonded to a least a part of the fourth surface. The first adhesive layer makes the separator at the first region, the separator at the second region, and the first lateral face form a whole, and the second adhesive layer makes the first tab, the second tab, a part of the separator at the first end face, and the second lateral face form a whole, so as to reduce the risk of a short circuit of the battery cell caused by inward shrinkage of the separator at the first end face when the battery cell is dropping, and improve the safety of the battery cell.

In some embodiments of this application, the battery cell further includes a second tab lead. One end of the second tab lead is disposed on the third surface or the fourth surface. The first adhesive layer is partially bonded to a surface of the second tab lead, or the second adhesive layer is partially bonded to a surface of the second tab lead, so as to reduce the risk of a short circuit caused by the contact between the second tab lead and the electrode assembly.

In some embodiments of this application, the battery cell further includes a third adhesive layer configured to protect the first tab or the first tab lead bonded by the third adhesive layer, so as to reduce the risk of a short circuit caused by the contact between the electrode assembly and the first tab part or first tab lead part bonded by the third adhesive layer.

In some embodiments of this application, the battery cell further includes a fourth adhesive layer partially bonded to a surface of the first tab lead. A part of the fourth adhesive layer is disposed between the first surface and the third adhesive layer. At least a part of the fourth adhesive layer is further connected to the third adhesive layer. The fourth adhesive layer is configured to seal at least a part of the first tab lead.

In some embodiments of this application, the battery cell further includes a fifth adhesive layer partially bonded to the second surface. A part of the fifth adhesive layer is disposed between the second surface and the second adhesive layer. At least a part of the fifth adhesive layer is bonded to the second adhesive layer. The fifth adhesive layer is configured to seal at least a part of the first tab lead.

In some embodiments of this application, the battery cell further includes a sixth adhesive layer. The sixth adhesive layer is bonded to the second end face and extends from the second end face to the first lateral face and the second lateral face separately. A third direction is perpendicular to the first direction and the second direction. Along the third direction, a width of the sixth adhesive layer is 3/4 to 6/5 of a width of the electrode assembly. The sixth adhesive layer makes the separator at the second end face, the first lateral face, and the second lateral face form a whole, so as to reduce the risk of a short circuit of the battery cell caused by inward shrinkage of the separator at the first region when the battery cell is dropping.

In some embodiments of this application, the electrode assembly is formed by winding or stacking the first electrode plate, the separator, and the second electrode plate. The first tab includes a plurality of first tab units. One end of each first tab unit is connected to one of the layer of the first electrode plate of the electrode assembly, and other ends of the plurality of first tab units are welded together.

An embodiment of this application further provides a battery. The battery includes a housing and the battery cell according to any one of the foregoing embodiments. The battery cell is disposed in the housing.

An embodiment of this application further provides an electrical device. The electrical device includes the battery according to any one of the foregoing embodiments.

In the battery cell, the battery containing the battery cell, and the electrical device according to this application, the first adhesive layer makes the separator at the first region and the first lateral face form a whole, and the second adhesive layer makes a part of the separator at the first end face and the second lateral face form a whole, so as to reduce the risk of a short circuit of the battery cell caused by inward shrinkage of the separator at the first end face when the battery cell is dropping, improve the safety of the battery cell, and in turn, improve the safety of the battery and the electrical device in use.

### BRIEF DESCRIPTION OF DRAWINGS

FIG. 1 is a schematic structural diagram of an electrode assembly in a battery cell according to an embodiment of this application;

FIG. 2 is a schematic structural diagram of a first adhesive layer in a battery cell according to an embodiment of this application;

FIG. 3 is a schematic structural diagram of a second adhesive layer in a battery cell according to an embodiment of this application;

FIG. 4 is a schematic structural diagram of a third part in a battery cell according to an embodiment of this application;

FIG. 5 is a schematic structural diagram of a packaging bag in a battery cell according to an embodiment of this application;

FIG. 6 is a schematic exploded view of a packaging bag in a battery cell according to an embodiment of this application;

FIG. 7 is a schematic structural diagram of a fourth part in a battery cell according to an embodiment of this application;

FIG. 8 is a schematic structural diagram of a third adhesive layer in a battery cell from a first viewing angle according to an embodiment of this application;

FIG. 9 is a schematic structural diagram of a third adhesive layer in a battery cell from a second viewing angle according to an embodiment of this application;

FIG. 10 is a schematic structural diagram of a sixth adhesive layer in a battery cell from a first viewing angle according to an embodiment of this application;

FIG. 11 is a schematic structural diagram of a sixth adhesive layer in a battery cell from a second viewing angle according to an embodiment of this application;

FIG. 12 is a schematic structural diagram of a fifth part in a battery cell according to an embodiment of this application;

FIG. 13 is a schematic structural diagram of a sixth part in a battery cell according to an embodiment of this application;

FIG. 14 is a schematic structural diagram of a ninth adhesive layer in a battery cell according to an embodiment of this application;

FIG. 15 is a cross-sectional view obtained by sectioning along an A-A section line shown in FIG. 2;

FIG. 16 is a cross-sectional view obtained by sectioning along a B-B section line shown in FIG. 2; and

FIG. 17 is a schematic structural diagram of an electrical device according to an embodiment of this application.

### LIST OF REFERENCE NUMERALS

battery cell 100
battery 200
electrical device 300
electrode assembly 10
first lateral face 10a
second lateral face 10b
first end face 10c
second end face 10d
first region 10e
third lateral face 10f
fourth lateral face 10g
second region 10h
first electrode plate 11
second electrode plate 12
Separator 13
first tab 20
first surface 21
second surface 22
first tab unit 23
first adhesive layer 30
first part 31
second part 32
third part 33
fourth part 34
second adhesive layer 40
first tab lead 51
second tab lead 52
second tab 60
third surface 61
fourth surface 62
third adhesive layer 71
fourth adhesive layer 72
fifth adhesive layer 73
sixth adhesive layer 74
fifth part 741
sixth part 742
seventh adhesive layer 75
eighth adhesive layer 76
ninth adhesive layer 77
packaging bag 80
first direction X
second direction Z
third direction Y

This application is further described below with reference to the following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated. The terms “vertical”, “horizontal”, “left”, “right”, “top”, “bottom”, and similar expressions are used herein merely for ease of description but not for limiting this application.

Understandably, when two components are arranged parallel or perpendicular to each other along the same direction, a tolerable angle may exist between the two components. The angle between two components permits a tolerance of 0 to ±10%, and a measured value of the angle between the two components may be greater than, equal to, or less than the nominal value with a tolerance of 0 to ±10%.

An embodiment of this application provides a battery cell. The battery cell includes an electrode assembly and a first tab. The electrode assembly includes a first electrode plate, a second electrode plate, and a separator disposed between the first electrode plate and the second electrode plate. An outer surface of the electrode assembly includes a first lateral face and a second lateral face disposed opposite to each other along a first direction, and a first end face and a second end face disposed opposite to each other along a second direction. One end of the first tab is electrically connected to the first electrode plate, and another end of the first tab extends out from the first end face. The first tab includes a first surface and a second surface. The first surface is oriented toward the first lateral face, and the second surface is oriented away from the first lateral face. The first end face includes a first region. The first region is located between the first surface and the first lateral face. The battery cell further includes a first adhesive layer and a second adhesive layer. The first adhesive layer is affixed to the first region and extends from the first region to the first lateral face. A part of the first adhesive layer is bonded to the separator located at the first region. The second adhesive layer is bonded to at least a part of the second surface and extends from the second surface to the second lateral face. A part of the second adhesive layer is bonded to the separator located at the first end face.

The first adhesive layer makes the separator at the first region and the first lateral face form a whole, and the second adhesive layer makes a part of the separator at the first end face and the second lateral face form a whole, so as to reduce the risk of a short circuit of the battery cell caused by inward shrinkage of the separator at the first end face when the battery cell is dropping, and improve the safety of the battery cell.

The following further describes the embodiments of this application with reference to drawings.

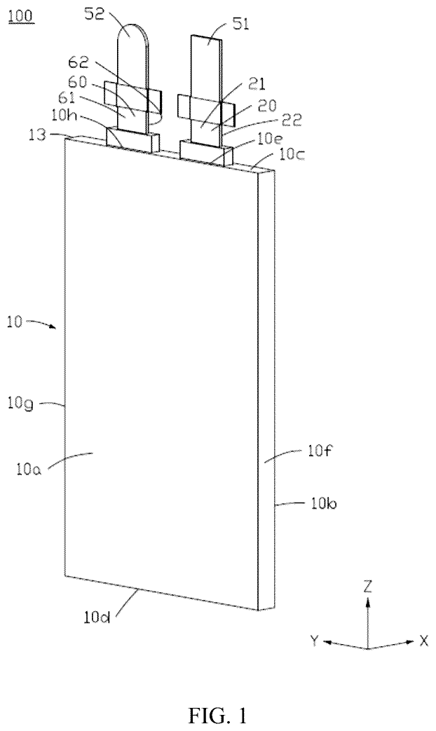

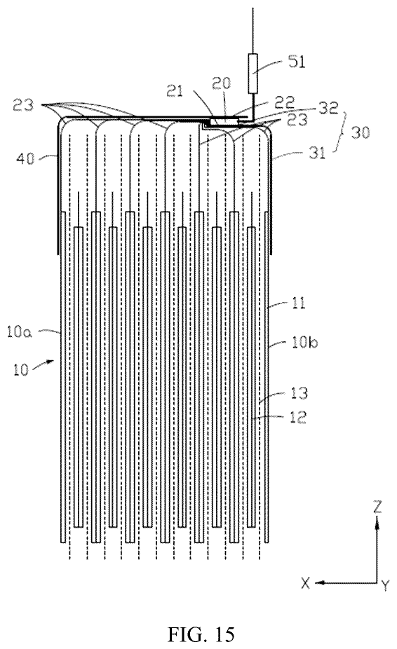

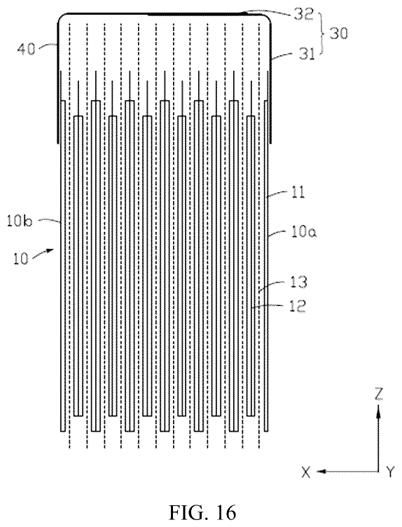

Referring to FIG. 1, an embodiment of this application provides a battery cell 100. The battery cell 100 includes an electrode assembly 10 and a first tab 20. The electrode assembly 10 includes a first electrode plate 11, a second electrode plate 12, and a separator 13 disposed between the first electrode plate 11 and the second electrode plate 12 (as shown in FIG. 15 and FIG. 16).

An outer surface of the electrode assembly 10 includes a first lateral face 10a and a second lateral face 10b disposed opposite to each other along a first direction X, and a first end face 10c and a second end face 10d disposed opposite to each other along a second direction Z.

One end of the first tab 20 is electrically connected to the electrode assembly 10, and another end of the first tab 20 extends out from the first end face 10c. In some embodiments, a part, extending out of the first end face 10c, of the first tab 20 is bent from the second lateral face 10b toward the first lateral face 10a, so as to reduce the packaging space occupied by the first tab 20 in the second direction Z and increase the energy density of the battery.

The first tab 20 includes a first surface 21 and a second surface 22. The first surface 21 is oriented toward the first lateral face 10a, and the second surface 22 is oriented away from the first lateral face 10a. The first end face 10c includes a first region 10e. The first region 10e is located between the first surface 21 and the first lateral face 10a.

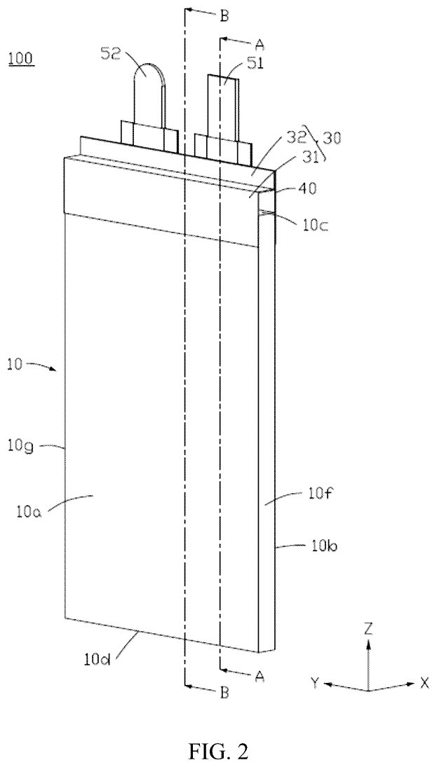

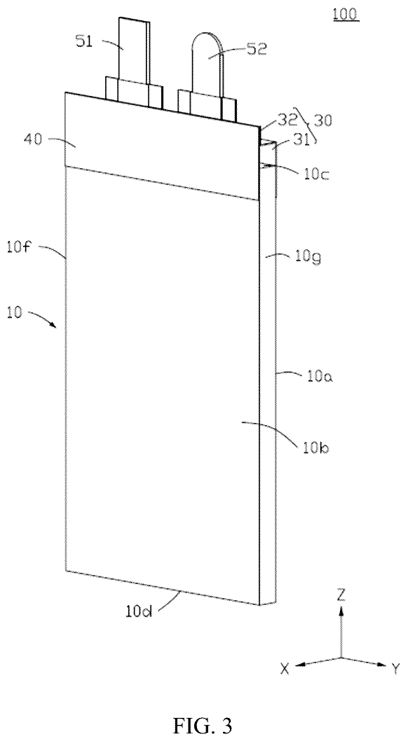

Referring to FIG. 2, FIG. 3, FIG. 15, and FIG. 16 together, the battery cell 100 further includes a first adhesive layer 30 and a second adhesive layer 40. The first adhesive layer 30 is affixed to the first region 10e and extends from the first region 10e to the first lateral face 10a. A part of the first adhesive layer 30 is bonded to a part of the separator 13 located at the first region 10e so that the separator 13 at the first region 10e combines with the first lateral face 10a to form a whole. In this way, when the separator 13 is impacted, the separator 13 can be prevented from shrinking because the separator 13 is bonded to the first adhesive layer 30, thereby reducing the risk of a short circuit of the battery cell 100 caused by the inward shrinkage of the separator 13 at the first region 10e when the battery cell 100 is dropping.

In some embodiments, along the second direction Z, the height of the first adhesive layer 30 on the first lateral face 10a ranges from 3 mm to 15 mm. Optionally, the height of the first adhesive layer 30 on the first lateral face 10a is one of 3 mm, 4 mm, 5 mm, 6 mm, 7 mm, 8 mm, 9 mm, 10 mm, 11 mm, 12 mm, 13 mm, 14 mm, 15 mm, or the like.

The second adhesive layer 40 is bonded to at least a part of the second surface 22 and extends from the second surface 22 to the second lateral face 10b. A part of the second adhesive layer 40 is bonded to a part of the separator 13 located at the first end face 10c so that the part of separator 13 at the first end face 10c combines with the second lateral face 10b to form a whole, thereby reducing the risk of a short circuit of the battery cell 100 caused by the inward shrinkage of the part of separator 13 at the first end face 10c when the battery cell 100 is dropping.

In some embodiments, the second surface 22 is oriented away from the second lateral face 10b in the second direction Z. On the first end face 10c, the separator 13 in a region between the second surface 22 and the second lateral face 10b is bonded to the second adhesive layer 40. Understandably, in some other embodiments, the second surface 22 is flush with the second lateral face 10b in the second direction Z, and therefore, the second adhesive layer 40 directly extends from the second surface 22 to the second lateral face 10b.

In some embodiments, along the second direction Z, the height of the second adhesive layer 40 on the second lateral face 10b ranges from 3 mm to 15 mm. Optionally, the height of the second adhesive layer 40 on the second lateral face 10b is one of 3 mm, 4 mm, 5 mm, 6 mm, 7 mm, 8 mm, 9 mm, 10 mm, 11 mm, 12 mm, 13 mm, 14 mm, 15 mm, or the like.

In the battery cell 100, the first adhesive layer 30 makes the separator 13 at the first region 10e and the first lateral face 10a form a whole, and the second adhesive layer 40 makes a part of the separator 13 at the first end face 10c and the second lateral face 10b form a whole, so as to reduce the risk of a short circuit of the battery cell 100 caused by inward shrinkage of the separator 13 at the first end face 10c when the battery cell 100 is dropping, and improve the safety of the battery cell 100.

Still referring to FIG. 2 and FIG. 3, in some embodiments, the third direction Y is perpendicular to the first direction X and the second direction Z. The third direction Y is a width direction of the first adhesive layer 30 and the electrode assembly 10. Along the third direction Y, a ratio of the width of the first adhesive layer 30 to the width of the electrode assembly 10 ranges from 3/4 to 6/5, that is, a ratio of the width of the first adhesive layer 30 to the width of the first lateral face 10a ranges from 3/4 to 6/5; and/or, a ratio of the width of the second adhesive layer 40 to the width of the electrode assembly 10 ranges from 3/4 to 6/5, that is, a ratio of the width of the second adhesive layer 40 to the width of the second lateral face 10b ranges from 3/4 to 6/5. When the ratio is less than 3/4, the bonding area between the first adhesive layer 30 or the second adhesive layer 40 and the separator 13 is relatively small, and the bonding stability between the adhesive layer and the separator is relatively low. Consequently, when the battery cell 100 drops, the impact of the electrolyte solution onto the separator 13 at the first end face 10c can hardly be alleviated, and it is difficult to prevent the separator 13 at the first end face 10c from shrinking inward and causing a risk of a short circuit of the battery cell 100. However, when the ratio is greater than 6/5, the spacing between the electrode assembly 10 and the inner surface of the packaging bag 80 in the width direction of the electrode assembly is caused to be overly large, thereby impairing the energy density of the battery cell 100.

Optionally, the ratio of the width of the first adhesive layer 30 to the width of the electrode assembly 10 is one of 3/4, 4/5, 17/20, 9/10, 19/20, 1, 21/20, 11/10, 23/20, 6/5, or the like; and the ratio of the width of the second adhesive layer 40 to the width of the electrode assembly 10 is one of 3/4, 4/5, 17/20, 9/10, 19/20, 1, 21/20, 11/10, 23/20, 6/5, or the like.

When the ratio of the width of the second adhesive layer 40 to the width of the electrode assembly 10 is 3/4 to 1, or when the ratio of the width of the second adhesive layer 40 to the width of the electrode assembly 10 is 1 to 6/5, the resulting effect is the same as that in the case of the first adhesive layer 30, details of which are omitted here.

Still referring to FIG. 2 and FIG. 3, in some embodiments, the first adhesive layer 30 includes a first part 31 and a second part 32 connected to the first part 31. The first part 31 is bonded to the first lateral face 10a and the first region 10e separately. The first part 31 is configured to be bonded to the separator 13 located at the first region 10e, and make the separator 13 at the first region 10e and the first lateral face 10a form a whole. Along the second direction Z, the second part 32 is partially bonded to the first surface 21, and further makes the first tab 20, the separator 13 at the first region 10e, and the first lateral face 10a form a whole, so as to reduce the risk of a short circuit of the battery cell 100 caused by inward shrinkage of the separator 13 at the first end face 10c when the battery cell 100 is dropping, and improve the safety of the battery cell 100.

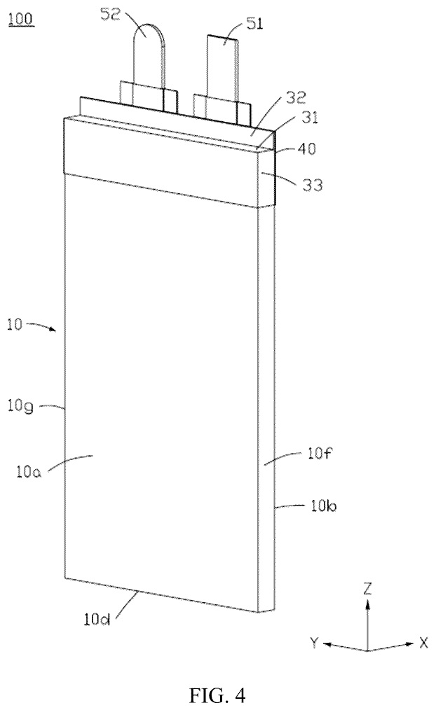

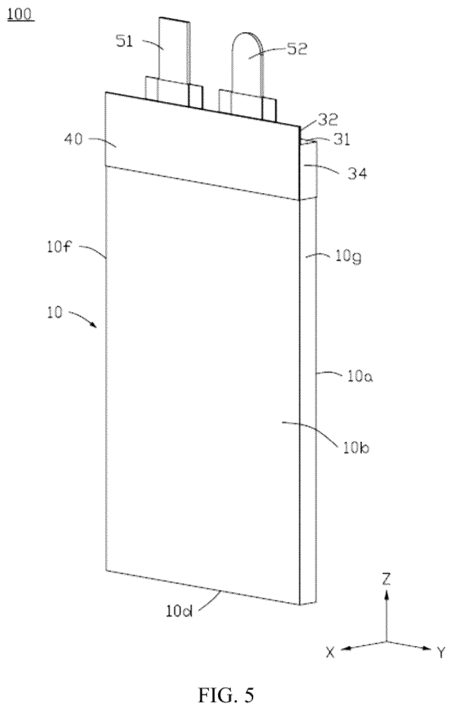

Referring to FIG. 4 and FIG. 5 together, in some embodiments, the electrode assembly 10 further includes a third lateral face 10f and a fourth lateral face 10g that are disposed opposite to each other along the third direction Y. In the third direction Y, two corresponding ends of the first adhesive layer 30 extend to be flush with the third lateral face 10f and the fourth lateral face 10g, respectively. In other words, the ratio of the width of the first adhesive layer 30 to the width of the first lateral face 10a is 1. In this way, when subjected to a pulling force of the first adhesive layer 30, the first lateral face 10a can distribute the pulling force uniformly, thereby reducing the risk of tearing the first lateral face 10a due to nonuniform force distribution.

In some embodiments, the first adhesive layer 30 further includes a third part 33 and a fourth part 34. The third part 33 is bonded to the third lateral face 10f. The fourth part 34 is bonded to the fourth lateral face 10g. In this way, the first lateral face 10a, the separator 13 at the first region 10e, the third lateral face 10f, and the fourth lateral face 10g form a whole, so as to further reduce the risk of a short circuit of the battery cell 100 caused by inward shrinkage of the separator 13 at the first end face 10c when the battery cell 100 is dropping.

In some embodiments, the third part 33 is connected to one end of the first part 31 in the third direction Y, and the third part 33 is bent toward the third lateral face 10f and bonded to the third lateral face 10f. The fourth part 34 is connected to another end of the first part 31 in the third direction Y, and the fourth part 34 is bent toward the fourth lateral face 10g and bonded to the fourth lateral face 10g.

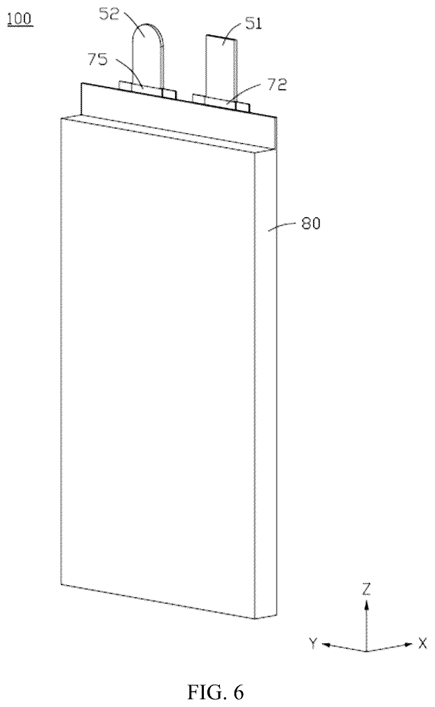

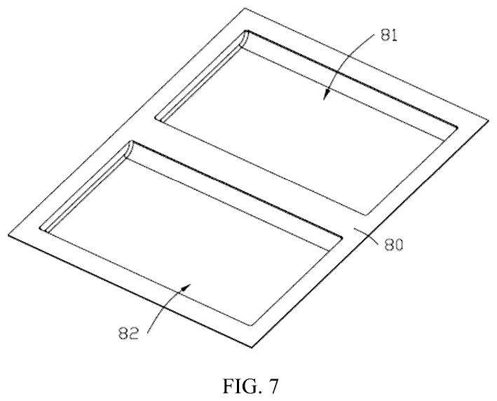

Referring to FIG. 1, FIG. 6, and FIG. 7 together, in some embodiments, the battery cell 100 further includes a packaging bag 80 configured to accommodate the electrode assembly 10. The packaging bag 80 includes a first recess 81 and a second recess 82. The first recess 81 and the second recess 82 are opposite to each other and jointly define an accommodation space to accommodate the electrode assembly 10. The sinking depth of the first recess 81 is greater than the sinking depth of the second recess 82. The first lateral face 10a is opposite to the bottom face of the first recess 81. The second lateral face 10b is opposite to the bottom face of the second recess 82.

Still referring to FIG. 2 and FIG. 3, in some embodiments, the battery cell 100 further includes a first tab lead 51. One end of the first tab lead 51 is disposed on the first surface 21 or the second surface 22. Another end of the first tab lead 51 extends out of the packaging bag 80.

Specifically, when one end of the first tab lead 51 is disposed on the first surface 21, the second part 32 is partially bonded to a surface of the first tab lead 51, and makes at least a part of the first tab lead 51 be located between the first surface 21 and the second part 32, so as to reduce the risk of a short circuit caused by the contact between the first tab lead 51 and the electrode assembly 10.

When one end of the first tab lead 51 is disposed on the second surface 22, the second adhesive layer 40 is partially bonded to the surface of the first tab lead 51, and makes at least a part of the first tab lead 51 be located between the second surface 22 and the second adhesive layer 40, so as to reduce the risk of a short circuit caused by the contact between the first tab lead 51 and the electrode assembly 10.

Still referring to FIG. 1, in some embodiments, the battery cell 100 further includes a second tab 60. One end of the second tab 60 is electrically connected to the electrode assembly 10, and another end of the second tab 60 extends out from the first end face 10c. In some embodiments, a part, extending out of the first end face 10c, of the second tab 60 is bent from the second lateral face 10b toward the first lateral face 10a, so as to reduce the packaging space occupied by the second tab 20 in the second direction Z and increase the energy density of the battery.

The second tab 60 includes a third surface 61 and a fourth surface 62. The third surface 61 is oriented toward the first lateral face 10a, and the fourth surface 62 is oriented away from the first lateral face 10a. The first end face 10c includes a second region 10h. The second region 10f is located between the third surface 61 and the first lateral face 10a.

Still referring to FIG. 2 and FIG. 3, the first adhesive layer 30 further extends from the first region 10e to the second region 10h. A part of the first adhesive layer 30 is bonded to the separator 13 located at the second region 10h so that the separator 13 at the first region 10e and the second region 10h combines with the first lateral face 10a to form a whole, thereby reducing the risk of a short circuit of the battery cell 100 caused by the inward shrinkage of the separator 13 at the first region 10e when the battery cell 100 is dropping.

In some embodiments, the first part 31 is bonded to the first lateral face 10a, the first region 10e, and the second region 10h separately. The first part 31 is configured to be bonded to the separator 13 located at the first region 10e and the separator 13 located at the second region 10h, and make the separator 13 at the first region 10e, the separator 13 located at the second region 10h, and the first lateral face 10a form a whole. Along the third direction Z, the second part 32 extends from the first surface 21 to the third surface 61, and further makes the first tab 20, the second tab 60, the separator 13 located at the first region 10e, the separator 13 located at the second region 10h, and the first lateral face 10a form a whole, so as to reduce the risk of a short circuit of the battery cell 100 caused by inward shrinkage of the separator 13 at the first end face 10c when the battery cell 100 is dropping, and improve the safety of the battery cell 100.

In some embodiments, the second adhesive layer 40 is further bonded to at least a part of the fourth surface 62, so as to make the first tab 20, the second tab 60, the part of separator 13 located at the first end face 10c, and the second lateral face 10b form a whole, thereby reducing the risk of a short circuit of the battery cell 100 caused by inward shrinkage of the separator 13 at the first end face 10c when the battery cell 100 is dropping, and improving the safety of the battery cell 100.

Still referring to FIG. 1, FIG. 2, FIG. 3, and FIG. 6, in some embodiments, the battery cell 100 further includes a second tab lead 52. One end of the second tab lead 52 is disposed on the third surface 61 or the fourth surface 62. Another end of the second tab lead 51 extends out of the packaging bag.

Specifically, when one end of the second tab lead 52 is disposed on the third surface 61, the first adhesive layer 30 is partially bonded to the surface of the second tab lead 52, and makes at least a part of the second tab lead 52 be located between the third surface 61 and the first adhesive layer 30, so as to reduce the risk of a short circuit caused by the contact between the second tab lead 52 and the electrode assembly 10. Specifically, the second part 32 of the first adhesive layer 30 is partially bonded to the surface of the first tab lead 51.

When one end of the second tab lead 52 is disposed on the fourth surface 62, the second adhesive layer 40 is partially bonded to the surface of the second tab lead 52, and makes at least a part of the second tab lead 52 be located between the fourth surface 62 and the second adhesive layer 40, so as to reduce the risk of a short circuit caused by the contact between the second tab lead 52 and the electrode assembly 10.

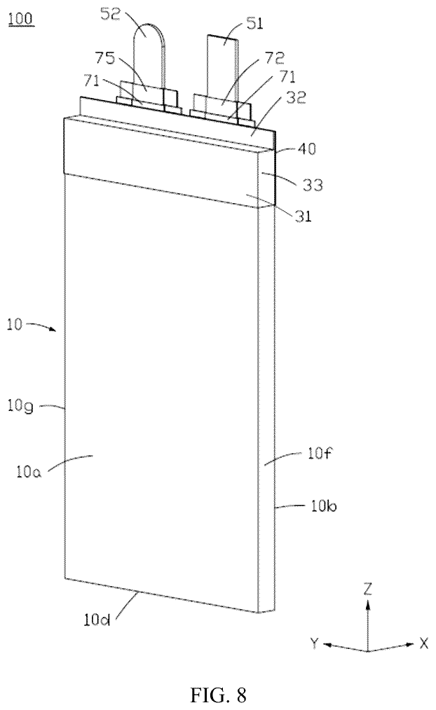

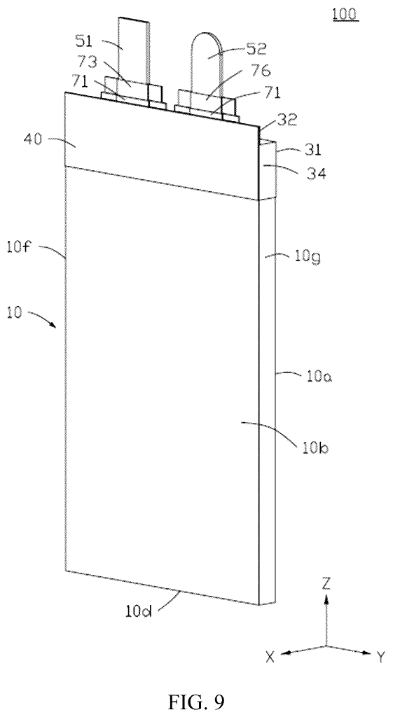

Referring to FIG. 8 and FIG. 9 together, in some embodiments, the battery cell 100 further includes a third adhesive layer 71 bonded to the first surface 21 and configured to protect the first tab 20 or the first tab lead 51 bonded by the third adhesive layer 71, so as to reduce the risk of a short circuit caused by the contact between the electrode assembly 10 and the first tab 20 part or first tab lead 51 part bonded by the third adhesive layer 71. Optionally, the thickness of the third adhesive layer 71 is 30 μm.

In some embodiments, along the third direction Y, the third adhesive layer 71 extends from the first surface 21 to the third surface 61, and is configured to protect the second tab 60 or the second tab lead 52 bonded by the third adhesive layer 71, so as to reduce the risk of a short circuit caused by the contact between the electrode assembly 10 and the second tab 60 part or second tab lead 52 part bonded by the third adhesive layer 71.

In some embodiments, the third adhesive layer 71 bonded to the first surface 21 and the third adhesive layer 71 bonded to the third surface 61 are disposed in one piece. Understandably, in some other embodiments, the third adhesive layer 71 bonded to the first surface 21 is disposed separately from the third adhesive layer 71 bonded to the third surface 61.

Still referring to FIG. 8 and FIG. 9, in some embodiments, the battery cell 100 further includes a fourth adhesive layer 72 partially bonded to a surface of the first tab lead 51. A part of the fourth adhesive layer 72 is disposed between the first surface 21 and the third adhesive layer 71. At least a part of the fourth adhesive layer 72 is further connected to the third adhesive layer 71. The fourth adhesive layer 72 is configured to seal at least a part of the first tab lead 51.

In some embodiments, the battery cell 100 further includes a fifth adhesive layer 73 partially bonded to the second surface 22. A part of the fifth adhesive layer 73 is disposed between the second surface 22 and the second adhesive layer 40. At least a part of the fifth adhesive layer 73 is bonded to the second adhesive layer 40. The fifth adhesive layer 73 is configured to seal at least a part of the second surface 22.

In some embodiments, the battery cell 100 further includes a seventh adhesive layer 75 partially bonded to a surface of the second tab lead 52. A part of the seventh adhesive layer 75 is disposed between the third surface 61 and the third adhesive layer 71. At least a part of the seventh adhesive layer 75 is further connected to the third adhesive layer 71. The seventh adhesive layer 75 is configured to seal at least a part of the third surface 61.

In some embodiments, the battery cell 100 further includes an eighth adhesive layer 76 partially bonded to the fourth surface 62. A part of the eighth adhesive layer 76 is disposed between the fourth surface 62 and the second adhesive layer 40. At least a part of the eighth adhesive layer 76 is bonded to the second adhesive layer 40. The eighth adhesive layer 76 is configured to seal at least a part of the fourth surface 62.

In some embodiments, the fourth adhesive layer 72, the fifth adhesive layer 73, the seventh adhesive layer 75, and the eighth adhesive layer 76 may be made of tab adhesive, and are configured to fuse with the packaging bag in a process sealing the packaging bag, so as to improve the hermeticity of the battery cell 100.

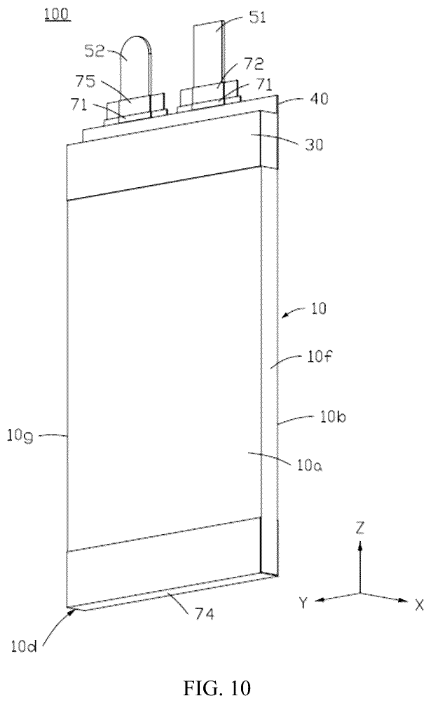

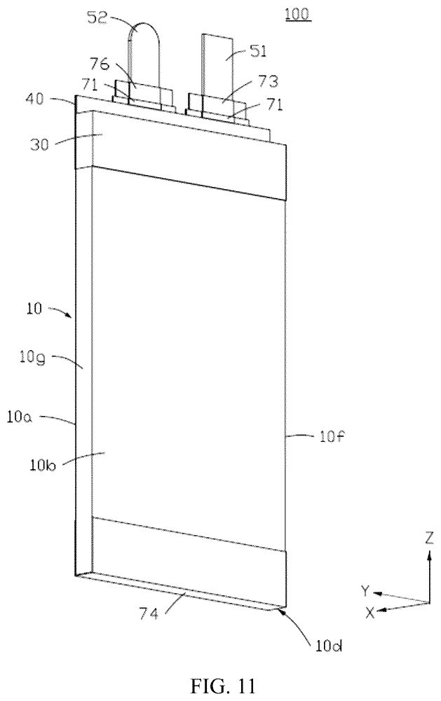

Referring to FIG. 10 and FIG. 11 together, in some embodiments, the battery cell 100 further includes a sixth adhesive layer 74. The sixth adhesive layer 74 is bonded to the second end face 10d, and extends from the second end face 10d to the first lateral face 10a and the second lateral face 10b separately, so as to make the separator 13 located at the second end face 10d, the first lateral face 10a, and the second lateral face 10b form a whole, thereby reducing the risk of a short circuit of the battery cell 100 caused by inward shrinkage of the separator 13 at the first region 10e when the battery cell 100 is dropping.

Along the third direction Y, the width of the sixth adhesive layer 74 is 3/4 to 6/5 of the width of the electrode assembly 10. When the ratio is less than 3/4, the bonding area between the sixth adhesive layer 74 and the separator 13 at the second end face 10d is relatively small, and the bonding stability between the adhesive layer and the separator is relatively low. Consequently, when the battery cell 100 drops, the impact of the electrolyte solution onto the separator 13 at the second end face 10d can hardly be alleviated, and it is difficult to prevent the separator 13 at the second end face 10d from shrinking inward and causing a risk of a short circuit of the battery cell 100. However, when the ratio is greater than 6/5, the spacing between the electrode assembly 10 and the inner surface of the packaging bag 80 in the width direction of the electrode assembly is caused to be overly large, thereby impairing the energy density of the battery cell 100.

Optionally, the ratio of the width of the sixth adhesive layer 74 to the width of the electrode assembly 10 is one of 3/4, 4/5, 17/20, 9/10, 19/20, 1, 21/20, 11/10, 23/20, 6/5, or the like.

In some embodiments, in the third direction Y, two corresponding ends of the sixth adhesive layer 74 extend to be flush with the third lateral face 10f and the fourth lateral face 10g, respectively. In other words, the ratio of the width of the sixth adhesive layer 74 to the width of the electrode assembly 10 is 1. In this way, when subjected to a pulling force of the sixth adhesive layer 74, the first lateral face 10a and the second lateral face 10b can distribute the pulling force uniformly, thereby reducing the risk of tearing the first lateral face 10a and the second lateral face 10b due to nonuniform force distribution.

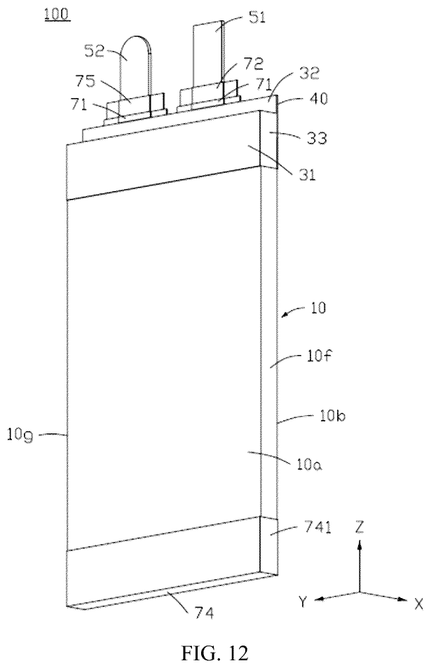

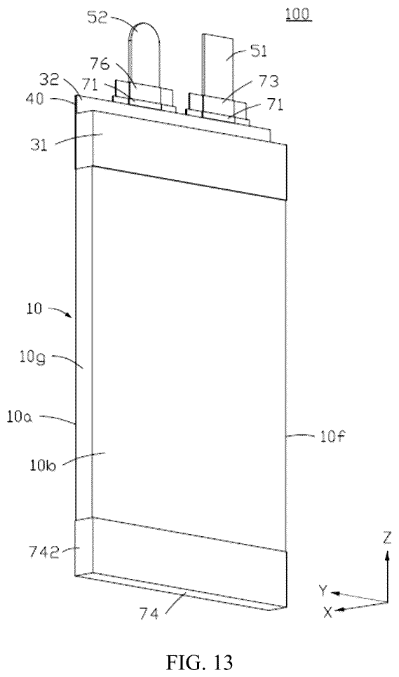

Referring to FIG. 12 and FIG. 13 together, in some embodiments, the sixth adhesive layer 74 further includes a fifth part 741 and a sixth part 742. The fifth part 741 is bonded to the third lateral face 10f. The sixth part 742 is bonded to the fourth lateral face 10g. In this way, the first lateral face 10a, the second lateral face 10b, the separator 13 at the second end face 10d, the third lateral face 10f, and the fourth lateral face 10g form a whole, so as to further reduce the risk of a short circuit of the battery cell 100 caused by inward shrinkage of the separator 13 at the second end face 10d when the battery cell 100 is dropping.

In some embodiments, along the second direction Z, the height of the sixth adhesive layer 74 on the first lateral face 10a ranges from 3 mm to 15 mm. Optionally, the height of the sixth adhesive layer 74 on the first lateral face 10a is one of 3 mm, 4 mm, 5 mm, 6 mm, 7 mm, 8 mm, 9 mm, 10 mm, 11 mm, 12 mm, 13 mm, 14 mm, 15 mm, or the like.

Along the second direction Z, the height of the sixth adhesive layer 74 on the second lateral face 10b ranges from 3 mm to 15 mm. Optionally, the height of the sixth adhesive layer 74 on the second lateral face 10b is one of 3 mm, 4 mm, 5 mm, 6 mm, 7 mm, 8 mm, 9 mm, 10 mm, 11 mm, 12 mm, 13 mm, 14 mm, 15 mm, or the like.

Understandably, in some embodiments, one end of the second tab 60 is electrically connected to the electrode assembly 10, and another end of the second tab 60 extends from the second end face 10d. Correspondingly, the battery cell 100 includes an adhesive layer structure similar to the first adhesive layer 30 and the second adhesive layer 40, so as to make the separator 13 located at the second end face 10d, the first lateral face 10a, and the second lateral face 10b form a whole, thereby reducing the risk of a short circuit of the battery cell 100 caused by inward shrinkage of the separator 13 at the first region 10e when the battery cell 100 is dropping.

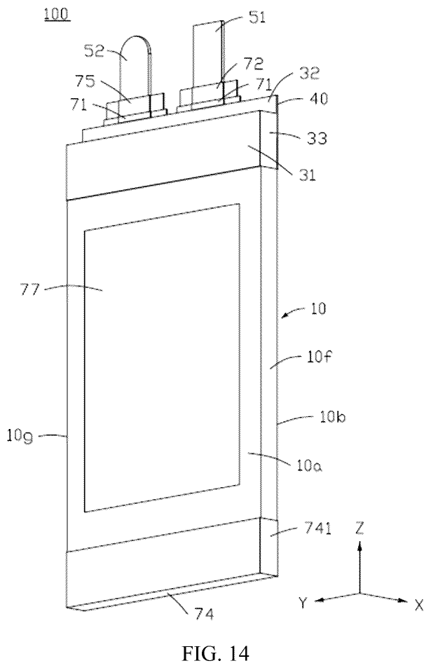

Referring to FIG. 14, in some embodiments, the battery cell 100 further includes a ninth adhesive layer 77. The ninth adhesive layer 77 is bonded to the first lateral face 10a and is configured to be bonded to the inner wall of the packaging bag in a process of sealing the packaging bag, reduce the displacement of the electrode assembly 10 in the packaging bag during a drop, and reduce the impact on the battery cell.

In some embodiments, along the second direction Z, the height of the ninth adhesive layer 77 ranges from 10 mm to 70 mm. Along the third direction Y, the width of the ninth adhesive layer 77 ranges from 10 mm to 70 mm.

In some embodiments, the height of the ninth adhesive layer 77 is one of 10 mm, 20 mm, 30 mm, 40 mm, 50 mm, 60 mm, 70 mm, or the like; and the width of the ninth adhesive layer 77 is one of 10 mm, 20 mm, 30 mm, 40 mm, 50 mm, 60 mm, 70 mm, or the like.

Referring to FIG. 15, in some embodiments, the electrode assembly 10 is formed by winding or stacking the first electrode plate 11, the separator 13, and the second electrode plate 12. Optionally, the first electrode plate 11 is a positive in polarity, and the second electrode plate 12 is negative; or, the first electrode plate 11 is negative in polarity, and the second electrode plate 12 is positive.

In some embodiments, the first tab 20 includes a plurality of first tab units 23. One end of each first tab unit 23 is connected to one of the layer of the first electrode plate 11 of the electrode assembly 10, and other ends of the plurality of first tab units 23 are welded together. The first tab lead 51 is connected to a weld joint of the plurality of first tab units 23.

In some embodiments, the second tab 60 includes a plurality of second tab units (not shown in the drawing). One end of each second tab unit is connected to one of the layer of the second electrode plate 12 of the electrode assembly 10, and other ends of the plurality of second tab units are welded together. The second tab lead 52 is connected to the weld joint of the plurality of second tab units. As can be seen from FIG. 15, the first adhesive layer 30 and/or the second adhesive layer 40 may be affixed to the outermost first tab unit 23 or may be affixed to a part of the separator 13, where the part extends beyond the first tab unit 23 in the Y direction, so as to enhance the adhesion of the first adhesive layer 30 and/or the second adhesive layer 40 to the separator 13 at the first region 10e.

Referring to FIG. 16, in some embodiments, in a region located between the second part 32 and the second adhesive layer 40 and oriented away from the first tab 20 and the second tab 60, the second part 32 and the second adhesive layer 40 are interconnected and bent toward the first lateral face 10a. In addition, a part of the first adhesive layer 30 and/or the second adhesive layer 40 is bonded to the separator 13 located in a non-tab region in the first region 10e, so as to increase the bonding area between the first adhesive layer 30 and/or the second adhesive layer 40 and the separator 13 in the non-tab region, and further improve the safety of the battery cell 100.

In some embodiments, the first adhesive layer 30 is made of a high-adhesion acrylic-based green adhesive or a poly (styrene-co-isoprene)-based gold-colored adhesive tape. The thickness of the first adhesive layer 30 ranges from 10 μm to 30 μm.

In some embodiments, the thickness of the first adhesive layer 30 is one of 10μ, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or the like.

In some embodiments, the second adhesive layer 40 is made of a high-adhesion acrylic-based green adhesive or a poly (styrene-co-isoprene)-based adhesive tape. The thickness of the second adhesive layer 40 ranges from 10 μm to 30 μm.

In some embodiments, the thickness of the second adhesive layer 40 is one of 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or the like.

In some embodiments, the ninth adhesive layer 77 is made of a poly (styrene-co-isoprene-co-styrene) hot-melt double-sided tape.

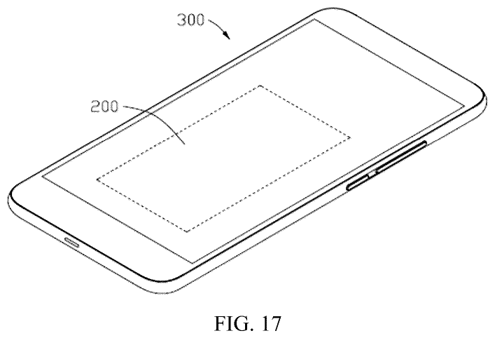

Referring to FIG. 17, this application further provides a battery 200. The battery includes a housing (not shown in the drawing). The battery 200 further includes the battery cell 100 according to any one of the foregoing embodiments. The battery cell 100 is disposed in the housing, and can improve safety of the battery 200. In some embodiments, the battery 200 further includes a protection circuit module (not shown in the drawing). The battery cell 100 and the protection circuit module are both disposed in the housing. The battery cell 100 is connected to the protection circuit module. The protection circuit module is configured to monitor and manage the battery cell 100 in the battery 200.

Still referring to FIG. 17, this application further provides an electrical device 300. The electrical device 300 includes the battery 200 disclosed in any one of the foregoing embodiments and capable of improving safety of the electrical device 300. The electrical device 300 may be an electronic device such as a mobile phone or tablet computer, or may be a mobile device such as an electric vehicle.

In the battery cell 100, the battery 200 containing the battery cell 100, and the electrical device 300, the first adhesive layer 30 makes the separator 13 at the first region 10e and the first lateral face 10a form a whole, and the second adhesive layer 40 makes a part of the separator 13 at the first end face 10c and the second lateral face 10b form a whole, so as to reduce the risk of a short circuit of the battery cell 100 caused by inward shrinkage of the separator 13 at the first end face 10c when the battery cell 100 is dropping, and improve the safety of the battery cell 100.

In addition, a person skilled in the art may make other variations to this application without departing from the essence of this application. The variations made based on the essence of this application still fall within the protection scope of this application.

What is claimed is:

1. A battery cell, comprising an electrode assembly and a first tab; wherein the electrode assembly comprises a first electrode plate, a second electrode plate, and a separator disposed between the first electrode plate and the second electrode plate; an outer surface of the electrode assembly comprises a first lateral face and a second lateral face disposed opposite to each other along a first direction, and a first end face and a second end face disposed opposite to each other along a second direction;
one end of the first tab is electrically connected to the first electrode plate, and another end of the first tab extends out from the first end face;
the first tab comprises a first surface and a second surface, the first surface is oriented toward the first lateral face, the second surface is oriented away from the first lateral face, the first end face comprises a first region, and the first region is located between the first surface and the first lateral face;
the battery cell further comprises:
a first adhesive layer, affixed to the first region and extending from the first region to the first lateral face, wherein a part of the first adhesive layer is bonded to the separator located at the first region; and
a second adhesive layer, bonded to at least a part of the second surface and extending from the second surface to the second lateral face, wherein a part of the second adhesive layer is bonded to the separator located at the first end face.

2. The battery cell according to claim 1, wherein a third direction is perpendicular to the first direction and the second direction; and, along the third direction, a ratio of a width of the first adhesive layer to a width of the electrode assembly ranges from 3/4 to 6/5, and/or a ratio of a width of the second adhesive layer to a width of the electrode assembly ranges from 3/4 to 6/5.

3. The battery cell according to claim 1, wherein, the first adhesive layer comprises a first part and a second part connected to the first part, the first part is bonded to the first lateral face and the first region separately; and, along the first direction, the second part is partially bonded to the first surface.

4. The battery cell according to claim 1, wherein the electrode assembly further comprises a third lateral face and a fourth lateral face disposed opposite to each other along a third direction; and, in the third direction, two corresponding ends of the first adhesive layer extend to be flush with the third lateral face and the fourth lateral face, respectively.

5. The battery cell according to claim 2, wherein the electrode assembly further comprises a third lateral face and a fourth lateral face disposed opposite to each other along a third direction; and, in the third direction, two corresponding ends of the first adhesive layer extend to be flush with the third lateral face and the fourth lateral face, respectively.

6. The battery cell according to claim 4, wherein the first adhesive layer further comprises a third part and a fourth part, the third part is bonded to the third lateral face, and the fourth part is bonded to the fourth lateral face.

7. The battery cell according to claim 5, wherein the first adhesive layer further comprises a third part and a fourth part, the third part is bonded to the third lateral face, and the fourth part is bonded to the fourth lateral face.

8. The battery cell according to claim 1, wherein, a part of the first tab extending out of the first end face, is bent from the second lateral face toward the first lateral face.

9. The battery cell according to claim 3, wherein the battery cell further comprises a packaging bag and a first tab lead; the electrode assembly is accommodated in the packaging bag; one end of the first tab lead is disposed on the first surface or the second surface, and another end of the first tab lead extends out of the packaging bag; and the second part is partially bonded to a surface of the first tab lead, or the second adhesive layer is partially bonded to a surface of the first tab lead.

10. The battery cell according to claim 1, wherein the battery cell further comprises a second tab, one end of the second tab is electrically connected to the electrode assembly, and another end of the second tab extends out from the first end face; the second tab comprises a third surface and a fourth surface, the third surface is oriented toward the first lateral face, the fourth surface is oriented away from the first lateral face, the first end face comprises a second region, and the second region is located between the third surface and the first lateral face; and
the first adhesive layer further extends from the first region to the second region, a part of the first adhesive layer is bonded to the separator located at the second region, and the second adhesive layer is further bonded to a least a part of the fourth surface.

11. The battery cell according to claim 10, wherein the battery cell further comprises a second tab lead, one end of the second tab lead is disposed on the third surface or the fourth surface; and the first adhesive layer is partially bonded to a surface of the second tab lead, or the second adhesive layer is partially bonded to a surface of the second tab lead.

12. The battery cell according to claim 1, wherein the battery cell further comprises a third adhesive layer bonded to the first surface.

13. The battery cell according to claim 3, wherein the battery cell further comprises a third adhesive layer bonded to the first surface.

14. The battery cell according to claim 12, wherein the battery cell further comprises a fourth adhesive layer partially bonded to a surface of a first tab lead, a part of the fourth adhesive layer is disposed between the first surface and the third adhesive layer, and at least a part of the fourth adhesive layer is further connected to the third adhesive layer.

15. The battery cell according to claim 12, wherein the battery cell further comprises a fifth adhesive layer partially bonded to the second surface, a part of the fifth adhesive layer is disposed between the second surface and the second adhesive layer, and at least a part of the fifth adhesive layer is bonded to the second adhesive layer.

16. The battery cell according to claim 1, wherein the battery cell further comprises a sixth adhesive layer, the sixth adhesive layer is bonded to the second end face and extends from the second end face to the first lateral face and the second lateral face separately, a third direction is perpendicular to the first direction and the second direction; and, along the third direction, a width of the sixth adhesive layer is 3/4 to 6/5 of a width of the electrode assembly.

17. The battery cell according to claim 1, wherein the electrode assembly is formed by winding or stacking the first electrode plate, the separator, and the second electrode plate; the first tab comprises a plurality of first tab units, one end of each first tab unit is connected to one of the layer of the first electrode plate of the electrode assembly, and other ends of the plurality of first tab units are welded together.

18. A battery, comprising a housing, wherein the battery further comprises the battery cell according to claim 1, and the battery cell is disposed in the housing.

19. The battery according to claim 18, wherein a third direction is perpendicular to the first direction and the second direction; and, along the third direction, a ratio of a width of the first adhesive layer to a width of the electrode assembly ranges from 3/4 to 6/5, and/or a ratio of a width of the second adhesive layer to a width of the electrode assembly ranges from 3/4 to 6/5.

20. An electrical device, wherein the electrical device comprises the battery according to claim 18.
